(19) United States
(12) Patent Application Publication
(10) Pub. No.: US 2025/0028559 A1
(43) Pub. Date: Jan. 23, 2025

(54) SYSTEM AND METHOD FOR SHARING HIGH BANDWIDTH MEMORY BETWEEN COMPUTER RESOURCES USING OPTICAL LINKS

(71) Applicant: LuxSemi, Inc., San Jose, CA (US)

(72) Inventors: Shahab Ardalan, San Jose, CA (US); Halleh Bostanchi, San Jose, CA (US)

(73) Assignee: LuxSemi, Inc., San Jose, CA (US)

(21) Appl. No.: 18/776,246

(22) Filed: Jul. 17, 2024

Related U.S. Application Data
(60) Provisional application No. 63/514,056, filed on Jul. 17, 2023.

(51) Int. Cl. G06F 9/50

(52) U.S. Cl. CPC G06F 9/5016

(57) ABSTRACT

Disclosed is a system and method for sharing memory and enlarging capacity between computer resources using optical links. In certain embodiments, high bandwidth memory is shared between multiple processing units through electrical and optical switching.

### PRIORITY CLAIM

This application claims priority to United States Provisional Patent Application 63/514,056, filed on Jul. 17, 2023. This application is incorporated herein by reference.

### BACKGROUND

The explosive growth of high performance computing (HPC), including machine learning (ML) and artificial intelligence (AI) models, has resulted in exponential demand on the computer power. Graphic processing units (GPU) have been favorable for such ML/AI models. However, their performance scaling is limited by the available immediate memory resources with ultra-low latency. This is important for the larger models, such as large language models and recommendation models. The limitation with the available technology is that maximum available high bandwidth memory (HBM) or any other kind of memory available for each GPU is limited by its shoreline. For larger models currently more memory bandwidth is accessible through other GPUs' memories. However, this architecture is very inefficient in utilizing the resources (memory and compute) as well as bandwidth.

In AI applications, the communication between computer node and memory is very sensitive and data flow between the computer and memory is expected to be very fast, necessitating high bandwidth. In such demanding applications, the memory serves as a “scratch pad” for the computer to perform its calculation and temporarily save its work. At the same time, each node also has a networking channel with other compute node, which has lower bandwidth and usually has high latency. This results in longer times for data to reach its destination compared to memory networking. This latency can become problematic in AI applications, as if one GPU runs out of its own memory and needs to access memory of other GPUs, data must flow through networking channel, which, due to its low bandwidth, is and slow, thereby reducing the efficiency of the system.

A more ideal configuration is if many GPUs share a pool of high bandwidth memories, while they also have their own dedicated high bandwidth memory. The disclosed system and method provides solutions for sharing HBM between many compute resources, such as GPUs. The solutions include both sharing HBM through electrical and optical switching. It is important to note that these solutions are enabled using an optical physical layer (PHY) that can extend the reach and density of electrical signals across wafers, substrates or panels.

Computing efficiency can be significantly improved with the use of all to all connections and broadcasting. Such connections have the advantage of simultaneously transmitting data to multiple components, thereby rendering more memory and processing capabilities in a close vicinity. Switching allows optical signals and electrical signals to be used interchangeably within the same system.

### BRIEF SUMMARY

Embodiments of the disclosed system and method provide solutions for sharing HBM between many computer resources, such as GPUs. The solutions include both sharing HBM through electrical and optical switching. A primary objective of the disclosed system and method is increase efficient transfer of data and reduce latency. It is important to note that these solutions are enabled using an optical physical layer (PHY) that can extend the reach and density of electrical signals across wafers, substrates or panels. Additionally, certain embodiments include all-to-all connections and broadcasting, which has the added advantage to enable more memory and computer availability in close vicinity. This is accomplished through the use of data transmission from one ASIC component to multiple ASIC components simultaneously.

### FIGURES

FIG. 1 depicts a representative embodiment of a computer system having sharing memory resources between two processing units.

FIG. 2 depicts a representative embodiment of a computer system architecture with additional HBM's and optical electrical engines, and having an ASIC switch.

FIG. 3 depicts a representative embodiment of a computer system wherein multiple HBM's are shared across the system, through the use of an optical switch.

FIG. 4 depicts a representative embodiment of a computer system having a single point of a computer node, between multiple and HBM's and a processor unit.

FIG. 5 depicts a representative embodiment of a computer system having the ability to accommodate a larger number of HBM's and processor units.

FIG. 6 depicts a representative embodiment of a computer system having an HBM switch active imposer, wherein multiple HBM's are stacked on the interposer.

FIG. 7 depicts a representative embodiment of a computer system having varying numbers of HBM's stacked on an interposer and an HBM electrical switch.

FIG. 8 depicts a representative embodiment of a computer system having HBM's and ASIC chips disposed on an interposer to enable all-to-all broadcasting.

### DETAILED DESCRIPTION

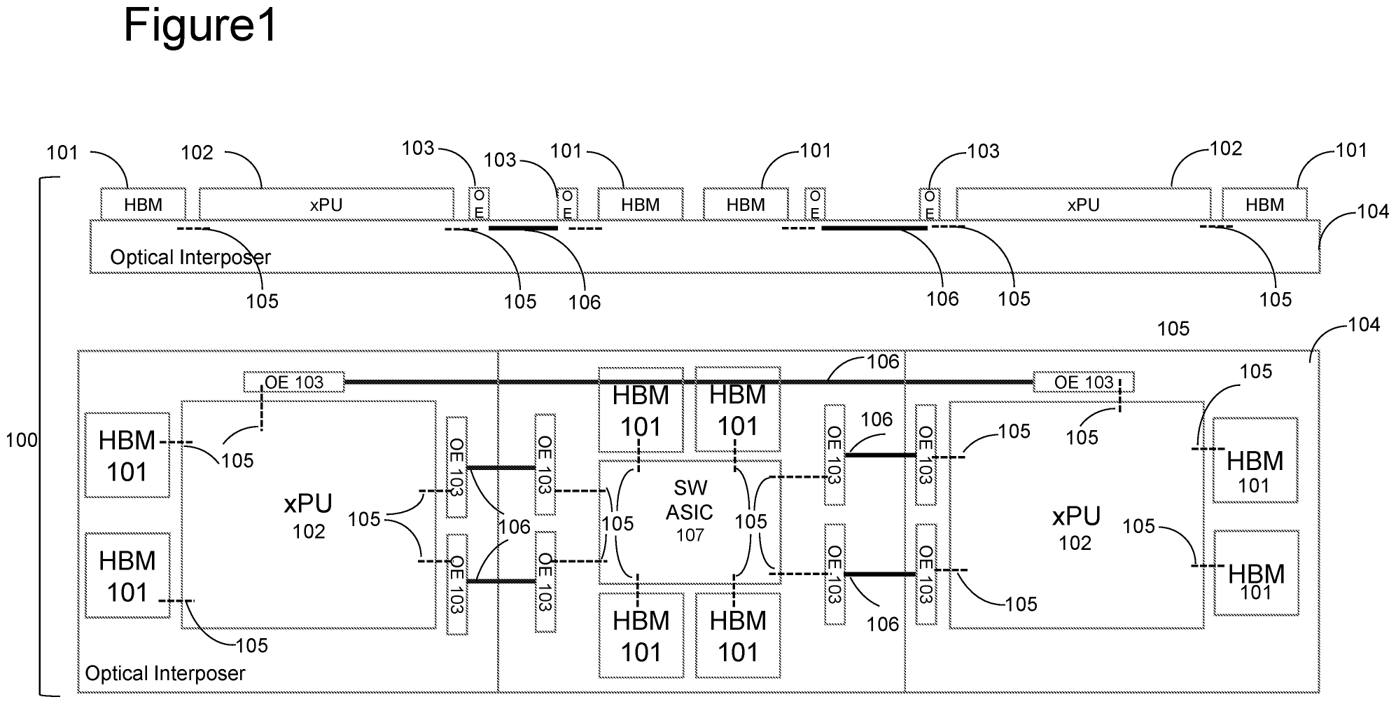

Disclosed is a system and method for sharing memory and enlarging capacity between computer resources using optical links. FIG. 1 displays a representative embodiment of such a system 100 with two graphical processing units. Various embodiments can be expanded to include more processing units and memory components. Memory components may include high bandwidth memory (HBM) Low-Power Double Data Rate (LPDDR), double data rate (DDR), graphics double data rate (GDDR), or any other acceptable memory component. Embodiments of such systems may include a power source, signal delivery components, software, firmware, and non-transitory computer readable media encoding computer readable instructions to carry out the disclosed methods. In this embodiment, a minimum of two processing units 102 sharing high bandwidth memory (HBM) 101 on one or more sides of the shoreline. A shoreline may be defined as the boundary or interface between the core logic area of a chip and the I/O (input/output) pads or other peripheral components. In certain embodiments, each shoreline of the computer engine can accommodate two or more HBMs 101 (more HBM's can be accommodated as the system allows). In such systems, two processing units 102 are thereby able to share four HBM's 101 (2GPU times 2HBM) through a third ASIC chip that switches between HBMs 101. The switching network here has no overhead and hence does not add latency, or only adds minimal latency. In such embodiments, an optical IO circuit module or optical electrical engine 103 replaces the HBM 101 at the side of the processing unit 102 that normally connects to the processing unit 102 and extends it to a farther distance. Complementary optical electrical engines 103 would receive the HBM 101 signal on the switch side and convert it to electrical signal 105, where consequently it will get switched and electrically connect to the actual HBM 101. Furthermore, the same optical electrical engines 103 can be used to optically connect two processing units 102 together. Such connections can be under available protocols, such as peripheral component interconnect express (PCIe), Universal Chiplet Interconnect Express (UCIe), bunch of wires (BOW), or other acceptable protocols. As used herein, the words connect and connection refer to components having the ability to transfer data and electrical or optical signals between each other. In this context, “connected” components do not need to be in physical contact.

A representative embodiment of data flow is as follows, an electrical signal 105 can be transmitted from a first HBM 101 to a first processing unit 102. The first processing unit 102 can then transmit the first electrical 105 signal to a first optical electrical engine 103. The first electrical signal 105 is then converted to a first optical signal 106. The first optical signal 106 can be transmitted between the first optical electrical engine 103 to a second optical electrical engine 103. The first optical signal is then converted to a second electrical signal 105, then transmitted to a second processing units, 102. The second electrical signal 105 is then transmitted to a second HBM 101. This process can be repeated in reverse and in certain embodiments, the optical signals can replace electrical signals and vice versa.

In addition to the embodiment described above, an ASIC switch 107 can be used in combination. An embodiment may include the additional steps of transmitting a first electrical signal 105 from the first high bandwidth memory 101 to first processing unit 102. The first electrical signal 105 would then be transmitted to a transmitting the first optical signal to the fourth optical electrical engine 103 and converted to a first optical signal 106. The first optical signal 106 would then be transmitted to a fourth optical electrical engine 103, where it would be converted to a second electrical signal 105. The second electrical signal 105 is then transmitted to the ASIC switch 107, and finally, to a third HBM 101.

In this embodiment the total number of HBM 101 used between two processors is not increased, however, all or some of the HBMs 101 are shared through the proposed technique.

This system and method can be implemented on an interposer that can be either optically/electrically active or fully passive. Such active interposer can be achieved through wafer level processing and reticle stitching techniques. For example, FIG. 1 depicts an embodiment wherein active electrical and optical interposer 105 with 3 reticle stitching. In such an application, three separate patterns, reticles, that are connected together cross-boundaries, are printed onto a printed wafer. In other embodiments, such architecture can be expanded and implemented through multiple (>3) reticles. The actual switching can be controlled through additional HBM 101 addressing commands that eliminates the need for further network layers. Such a configuration functions with current processing units designs as is, with. no additional circuit modules or floorplan change is required to be added in.

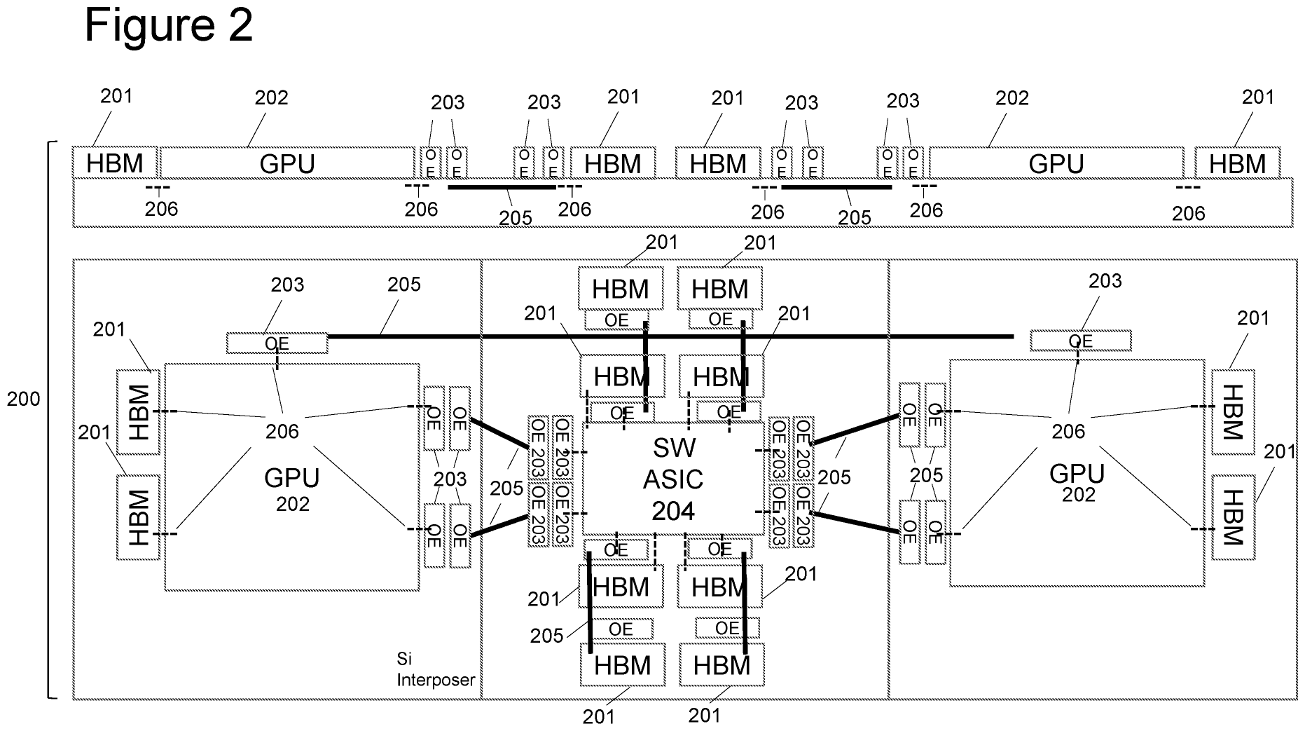

In the embodiment illustrated in FIG. 2, more shared HBMs 201 can be added to the system 200. In such embodiments, since more HBM's 201 are added, the processing units can have optional additional HBM IO added to increase the HBM 201 bandwidth density proportionally. It is noteworthy that the processing unit 202 does not need new circuit modules, it re-uses existing circuit modules for the additional HBM IO. Without this innovation, the additional HBM 201 IO would not achieve the desired result because of the larger distances these high speed lines need to travel in the electrical domain. In this case, two or more rows of optical IO circuit modules are needed on both GPU and switch side. On the switch to HBM 201 interface, the optical IO channel 205 can also be used to add more optical IO channels 205 in farther distance. In this case only the first row of HBM 201 can be connected using the electrical link (while this can also use optical IO), and the rest of the HBM 201 are connected through optical circuit modules 201, that can reach farther distance on the interposer 204, substrate or panel.

As in the prior embodiment, the embodiment illustrated by FIG. 2 illustrates a similar method, but with the addition of additional optical electrical engines 203 and additional HBM's 203. An electrical signal 206 may be transmitted between an HBM 201 and a processor unit 203. Optical electrical engines 202 convert electoral signals 206 to and from optical IO channel 205. The difference between the system 100 of FIG. 1 and the system 200 of FIG. 2 is the addition of multiple additional optical electrical engines 203 and additional HBM's 201 to increase efficiency of the system. In various embodiments of the system 200 of FIG. 2, two or more optical electrical engines 203 may be coupled to the ASIC switch 204 and multiple HBM's 201 may be coupled to multiple HBM's 201. Additionally, a single HBM 201 may be interfaced to multiple optical electrical engines 203.

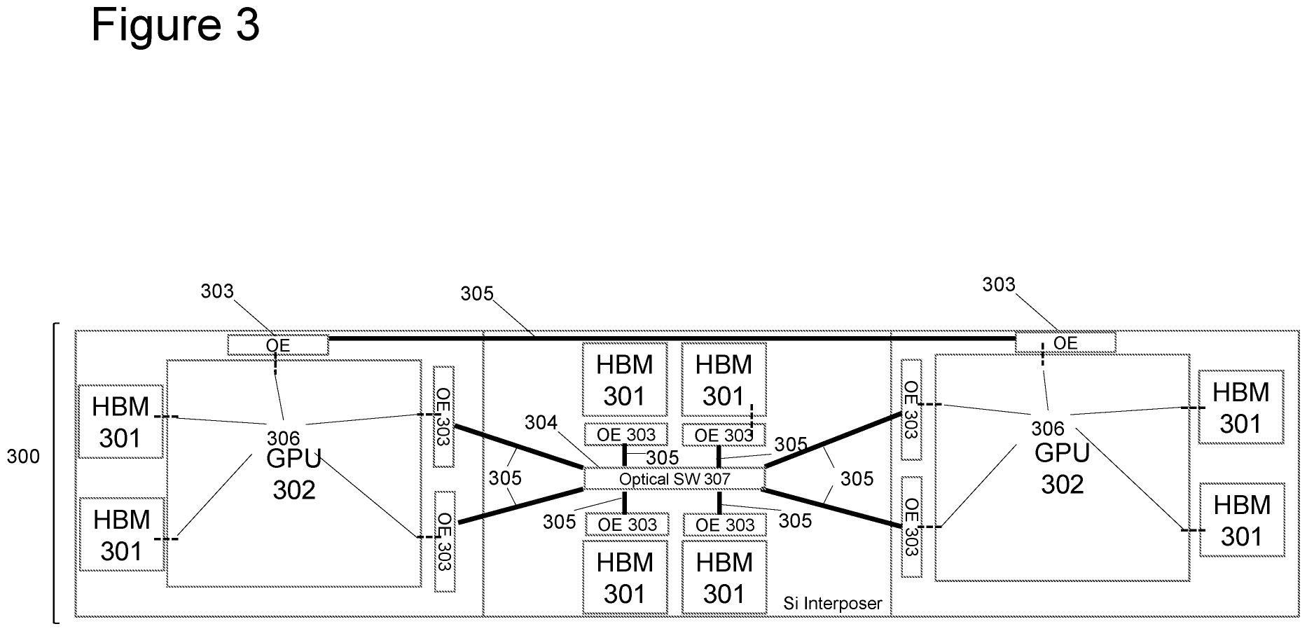

FIG. 3 illustrates an embodiment of a system 300 wherein the actual switching function is performed using optical switching rather than electrical switching. There are different ways to perform the topical switching. Various embodiments may employ one or more of the following switching techniques.
1. Thermo-optic Switching: Utilizes localized heating to change the refractive index of the waveguide material, thereby altering the path of light. This method is relatively slow but is simple and cost-effective.
2. Electro-optic Switching: Uses an electric field to change the refractive index of a material such as lithium niobate or Silicon-Germanium, allowing for high-speed switching. It is faster than thermo-optic switching but typically less efficient.
3. Acousto-optic Switching: Involves the interaction of sound waves with light waves in a material, changing the refractive index and thus the light path. This method offers moderate speed and can be used for dynamic beam steering and modulation.
4. Carrier Injection/Depletion: Alters the refractive index by injecting or depleting carriers (electrons and holes) in semiconductor materials like silicon. This method provides high-speed switching and is compatible with standard CMOS processes.
5. Micro-electromechanical Systems (MEMS) Switching: Uses tiny movable mirrors or waveguides to physically redirect the light path. MEMS switches offer low insertion loss and high isolation but can be slower and less reliable over long-term use.
6. Plasmonic Switching: Utilizes the interaction between light and free electrons at the interface of a metal and a dielectric to modulate the light path. This method allows for very compact devices with fast response times but can suffer from higher losses.

Such changes would reduce the number of electrical optical engines throughout the link and hence potentially have lower latency and power.

HMB's 301 transfer and receive electrical signals 306 to and from processor units 302. Optical electrical engines 303 convert electrical signals 306 to and from optical signals 305 and vice versa. An optical switch 307 allows for the exchange of optical signals between multiple optical electrical engines 303.

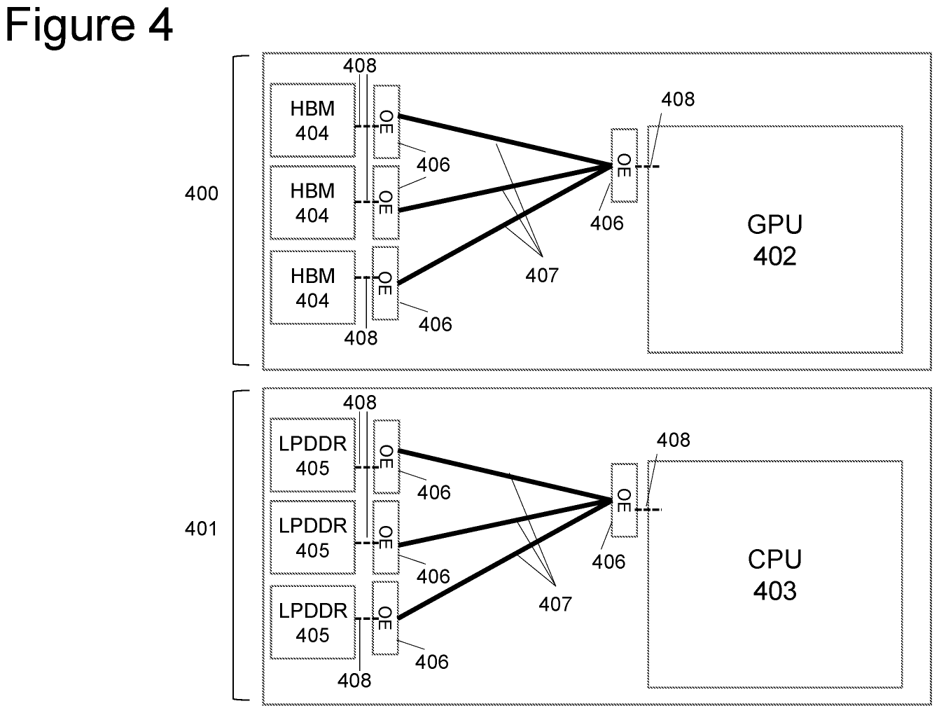

FIG. 4 illustrates an embodiment of a system 400 wherein the HBM 404 sharing happens to a single point of the computer node. This configuration increases the capacity of available HBM, DDR, LPDDR, GDDR, etc. for a given processing unit (GPU, CPU, TPU, etc.), while maintaining the same bandwidth density. In this configuration the optical circuit modules 408 including the switching circuitry in the electrical domain is placed next to the memory unit 408 (HBM, LPDDR, etc.) IO of the processing unit 403. Then the multiple optical waveguide sets are routed toward many memories including HBM 404, GDDR and LPDDR 405 connecting the optical circuit modules that eventually converts the optical signal 407 to electrical 408 and passes it to the memories. In this configuration multiple optical waveguide crossings are expected.

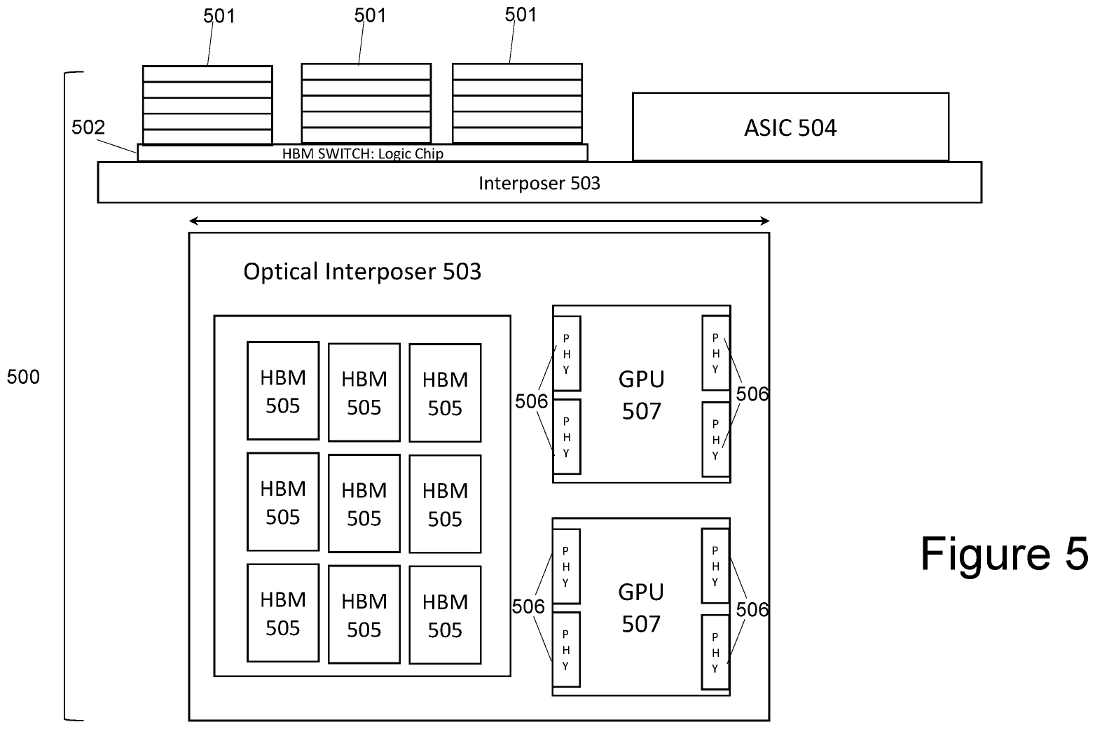

FIG. 5 illustrates embodiment of another system 500. This configuration accommodates a larger number of HBM's 505 shared with larger number of processors 507 (GPUs as shown as an embodiment illustrated in FIG. 5). The HBM IO from the processor unit side is immediately connected to the optical circuit modules that consequently is routed to the HBM 505 region using optical waveguides. On the HBM side the HBM signal is converted to electrical signal using optical circuit modules under (for larger HBM clusters) or next to (for below 2×2 HBM cluster) the HBM logic, where the function of switching is consequently being performed in the electrical domain. The electrical switching function can be either part of the HBM base logic or a separate circuitry within the active interposer 503. Further, an MBM switch 502 (logic chip) is disposed between the interposer 503 and stacks of HBM's 501. Also disposed on the Interposer 503 is an ASIC 504.

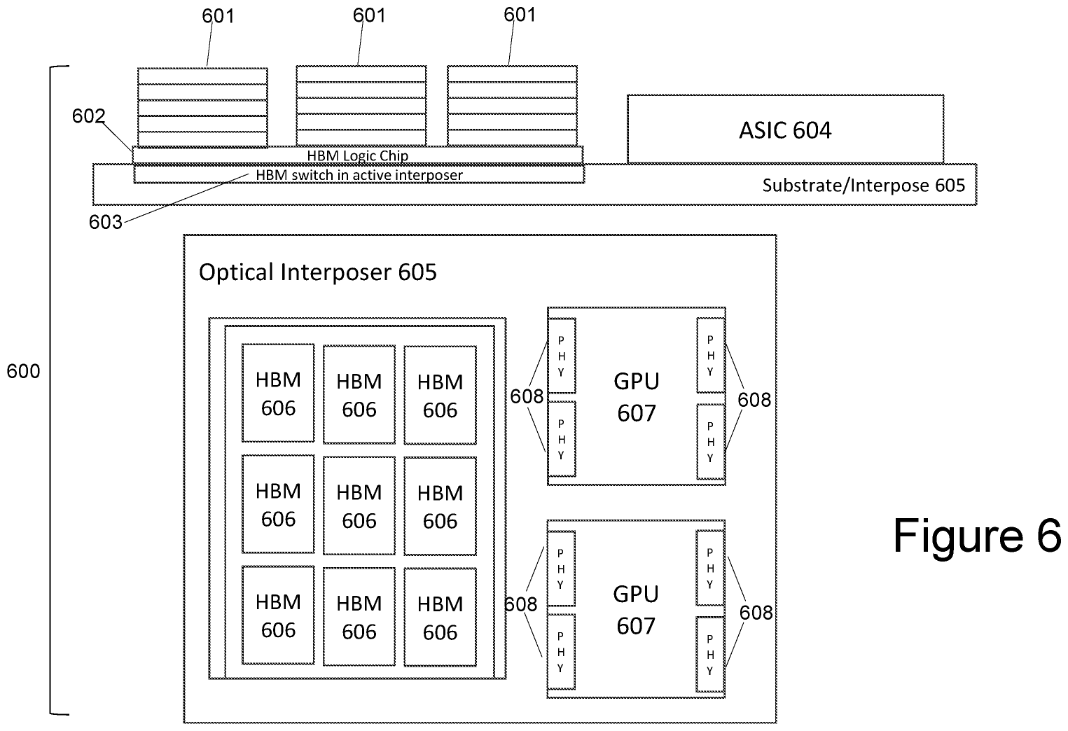

FIG. 6 illustrates an embodiment of a system 600 wherein a HBM switch 603 is disposed upon the substrate 605. In certain embodiments the substrate 605 comprises an interposer. Disposed on the HBM switch is an HBM logic chip 603. Disposed on the HBM logic chip are HBM's 601. The HBM's 601 are stacked and may comprise a stack of one to two or more. Also disposed on the interposer 605 is an ASIC 604. Processing units 607 are connected to multiple physical layers 608.

In certain embodiments, similar configuration can be used to implement a bufferless HBM and attach it on top of an ASIC, where the action of switching happens electrically inside the ASIC. The ASIC can also be part of the interposer or sit on top. The benefit of this configuration is that the HBM clusters can be at a farther distance (while still being on the same panel/board/interposer). This will help remove limitations on the maximum number of HBM as well as thermally separate the HBM with the processing unit.

This configuration, if used with more than two rows/columns of HBM requires the optical circuit modules be connected right below each HBM that enables a 2-dimensional IO density (as compared to shoreline limited) for the optical fabric. The actual number of HBM and its arrangement can be determined by the actual system architecture, while this invention can accommodate various arrangements. For example, the HBM can be in N by N or N by M arrays, where N and M are integer numbers.

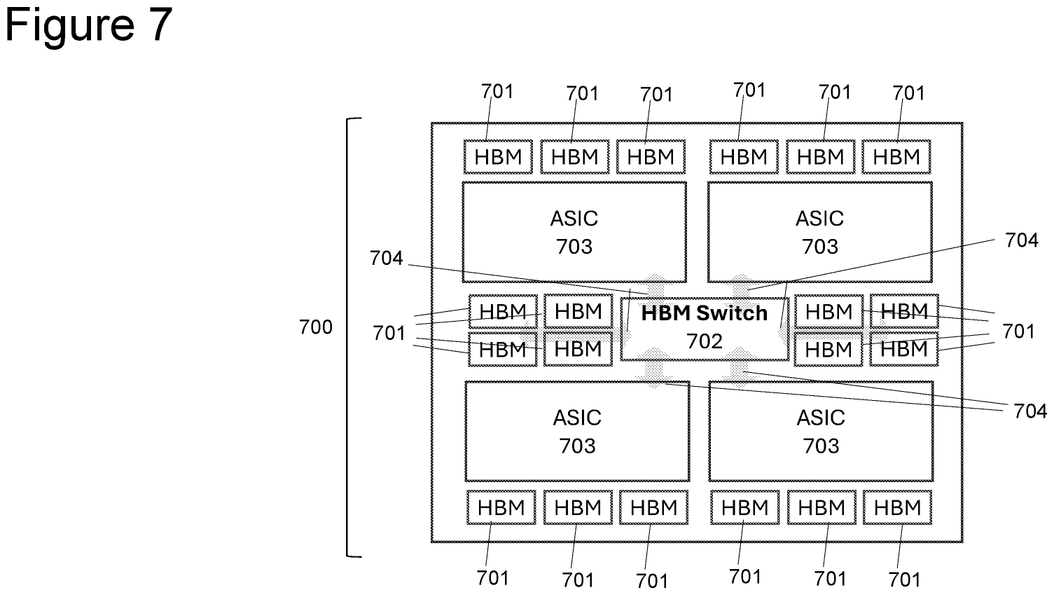

FIG. 7 depicts an embodiment of a system 700. Multiple HBM's 701 and ASIC's 703 are disposed around an HMB switch 702. In this embodiment, switching occurs in the electrical domain. Nonadjacent components are connected through an optical lane 704. In such a configuration, off-package communication occurs through east-west edges. Using an optical link or optical lane 704, more than one row or column of ASIC 703 or HBM 701 can be used.

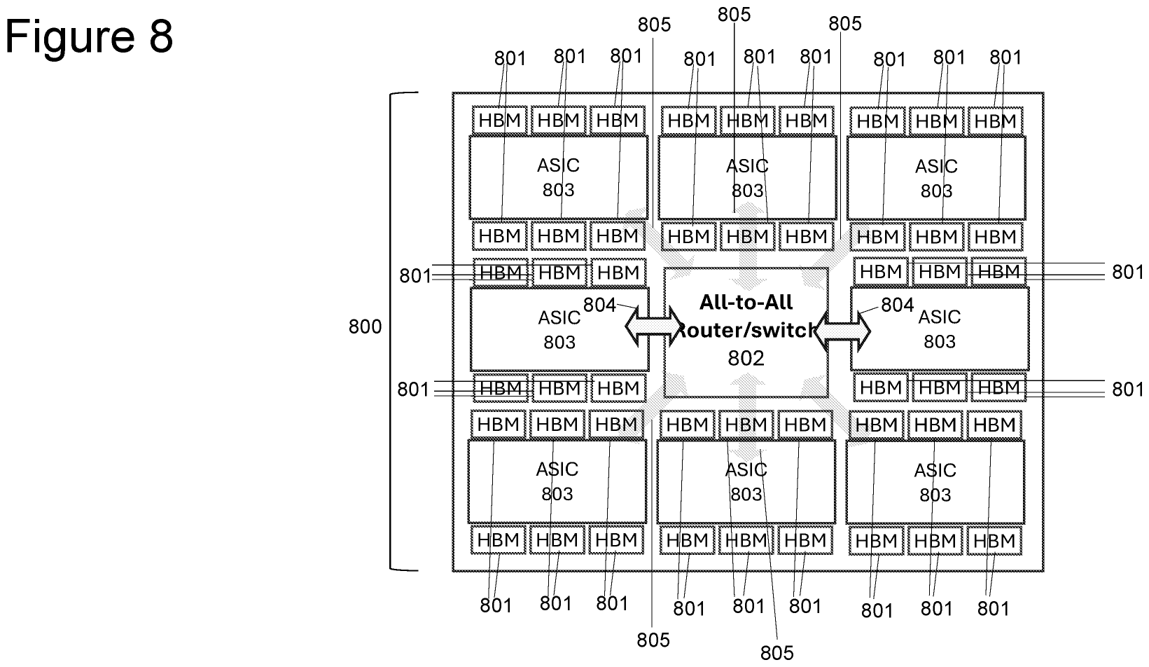

FIG. 8 depicts an embodiment of a system 800 utilizing and all-to-all switch 802. In an all-to-all broadcasting configuration, each processing unit (represented as an ASIC 801) is connected to a central router chip via dedicated electrical and/or optical links. These links have a specified bandwidth B for communication between each ASIC and the router chip. The optical channels can connect longer distances, while the neighboring chips (both router 802 and ASIC 803) can also be connected via electrical lanes.

The router chip 802 functions as an all-to-all router, facilitating communication between all connected ASICs 803. In such embodiments, Each ASIC 803 has a dedicated connection to the router chip 802, utilizing both electrical and optical links to ensure robust and high-speed data transfer. The total bandwidth of these links, denoted as B, determines the maximum data transfer rate between an ASIC 803 and the router 802. The router chip 802 is capable of managing multiple simultaneous data streams in electrical domain, acting as a central hub that directs data from any one ASIC 803 to all other ASICs 803. It dynamically allocates bandwidth based on the communication requirements of the connected ASICs 803.

In an all-to-all broadcast scenario, each ASIC 803 broadcasts data to every other ASIC 803 in the network.

For a system with N ASICs 803, each ASIC 803 needs to broadcast to N-1 other ASICs 803. Given the total bandwidth B between each ASIC 803 and the router 802, this bandwidth must be divided among the N-1 destination ASICs 803. For example, if there are 8 ASICs 803, each ASIC 803 broadcasts to 7 other ASICs 803. Therefore, the bandwidth B allocated to each communication channel from one ASIC 803 to another is B/7. This division ensures that each ASIC 803 can simultaneously broadcast to all other ASICs 803, albeit with reduced individual bandwidth per connection.

In such embodiments, there are also some architectural considerations. The design scales with the number of ASICs 803, maintaining consistent communication capabilities by adjusting the bandwidth allocation dynamically. Further, by dividing the bandwidth among all communication channels, the system ensures efficient utilization of available resources, allowing for effective parallel processing and data distribution. The router chip's 802 capability to allocate bandwidth based on the current architecture and communication needs provides flexibility in handling varying workloads and data traffic patterns.

For example, consider a network with eight ASICs, each having a dedicated bandwidth B link to the router chip. When ASIC 1 broadcasts data, it needs to send it to ASICs 2 through 8. The router chip allocates B/7 bandwidth to each of these seven connections. Simultaneously, ASIC 2 broadcasts to ASICs 1, 3 through 8, with the same bandwidth allocation. This ensures that all ASICs can send and receive data from every other ASIC, facilitating comprehensive data sharing and collaboration across the network. This configuration is particularly useful in GPU clusters used for high-performance computing tasks, where rapid and efficient data sharing between GPUs is critical for performance.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. It is intended, therefore, that the invention be defined by the scope of the claims that follow and that such claims be interpreted as broadly as reasonable.

What is claimed is:

1. A computing system comprising:
an interposer,
a first processing unit disposed on the interposer;
a second processing unit disposed on the interposer;
a first high bandwidth memory unit, disposed on the interposer, and connected to the first processing unit;
a second high bandwidth memory unit, disposed on the interpose, and coupled to the second processing unit;
a first optical electrical engine connected to the first processing unit; and
a second optical electrical engine connected to second processing unit.

2. The computing system of claim 1 wherein data is transmitted between the first processing unit and the second processing unit according to the method comprising the steps of:
transmitting a first electrical signal from the first high bandwidth memory to the first processing unit;
transmitting the first electrical signal from the first processing unit to the first optical electrical engine;
converting the first electrical signal to a first optical signal;
transmitting the first optical signal to a second optical electrical engine;
converting the first optical signal into a second electrical signal;
transmitting the second electrical signal to the second processing unit; and
transmitting the second electrical signal to the second high bandwidth memory.

3. The computing system of claim 1 wherein data is transmitted between the first processing unit and the second processing unit according to the method comprising the steps of:
transmitting a first optical signal from the first high bandwidth memory to the first processing unit;
transmitting the first optical signal from the first processing unit to the first optical electrical engine;
converting the first optical signal to a first electrical signal;
transmitting the first electrical signal to a second optical electrical engine;
converting the first electrical signal into a second optical signal;
transmitting the second optical signal to the second processing unit; and
transmitting the second optical signal to the second high bandwidth memory.

4. The computing system of claim 1 further comprising:
an ASIC switch disposed on the interposer;
a third optical electrical engine disposed on the interposer;
a fourth optical electrical engine disposed on the interposer and connected to the ASIC switch; and
a third high bandwidth memory disposed on the interposer.

5. The computing system of claim 4 wherein data is transmitted between the first processing unit and the second processing unit according to the method comprising the steps of:
transmitting the first electrical signal from the first processing unit to the third optical electrical engine;
converting the first electrical signal to a first optical signal;
transmitting the first optical signal to the fourth optical electrical engine;
converting the first optical signal to a second electrical signal;
transmitting the second electrical signal to the ASIC switch; and
transmitting the second electrical signal to third high bandwidth memory.

6. The computing system of claim 1 further comprising:
an optical switch disposed on the interposer;
a third optical electrical engine disposed on the interposer;
a fourth optical electrical engine disposed on the interposer and connected to the ASIC switch; and
a third high bandwidth memory disposed on the interposer.

7. The computing system of claim 6 wherein data is transmitted between the first processing unit and the second processing unit according to the method comprising the 8 steps of:
transmitting the first electrical signal from the first processing unit to the third optical electrical engine;
converting the first electrical signal to a first optical signal;
transmitting the first optical signal to the fourth optical electrical engine;
converting the first optical signal to a second electrical signal;
transmitting the second electrical signal to the optical switch; and
transmitting the second electrical signal to third high bandwidth memory.

8. A computing system comprising:
an interposer,
a first processing unit disposed on the interposer;
a first optical electrical switch connected to the first processing unit;
a second optical electrical switch connected to a first memory component; and
a third optical electrical switch connected to a second memory component.

9. The computing system of claim 8 wherein data is transmitted between the first processing unit and the second processing unit according to the method comprising the 32 steps of:
transmitting a first electrical signal from the first processing unit to the first optical electrical switch;
converting the first electrical signal to a first optical signal;
transmitting the first optical signal to the second optical electrical switch and to the second optical electrical switch;
converting the first optical signal at the second optical electrical switch to a second electrical signal;
converting the first optical signal and the third optical electrical switch to the second electrical signal; and
transmitting the second electrical signal to the first memory component and to the second memory component.

10. A method for enlarging the capacity of a computer system comprising the steps of:
transmitting a first electrical signal from a first memory component to a first processing unit;
transmitting the first electrical signal from the first processing unit to a first optical electrical engine;
converting the first electrical signal to a first optical signal;
transmitting the first optical signal to a second optical electrical engine;
converting the first optical signal into a second electrical signal;
transmitting the second electrical signal to a second processing unit; and
transmitting the second electrical signal to a second memory component.
